(19) United States
(12) Patent Application Publication
(10) Pub. No.: US 2014/0084039 A1
(43) Pub. Date: Mar. 27, 2014

(54) METHOD AND APPARATUS FOR SEPARATING WORKPIECES

(71) Applicant: ELECTRO SCIENTIFIC INDUSTRIES, INC., Portland, OR (US)

(72) Inventors: Haibin Zhang, Portland, OR (US); Michael Shane Noel, Portland, OR (US)

(73) Assignee: ELECTRO SCIENTIFIC INDUSTRIES, INC., Portland, OR (US)

(21) Appl. No.: 14/033,336

(22) Filed: Sep. 20, 2013

Related U.S. Application Data
(60) Provisional application No. 61/704,997, filed on Sep. 24, 2012.

(51) Int. Cl. B26F 3/02

(52) U.S. Cl. CPC B26F 3/02
USPC 225/2; 225/96

(57) ABSTRACT

The invention is method and an apparatus for performing the method having the steps of providing a workpiece, cleaving the workpiece to form a first unit piece and a second unit piece having a spatial relationship with the first unit piece in which the second unit piece abuts the first unit piece. Without substantially altering the spatial relationship after cleaving the workpiece, forming a first crack within the first unit piece and propagating the first crack from the first unit piece into the second unit piece.

### CROSS REFERENCE TO RELATED APPLICATIONS

This application is a Non-Provisional application which claims benefit of U.S. Patent Provisional Application Ser. No. 61/704,997, which was filed on Sep. 24, 2012, the contents of which are herein incorporated by reference in their entirety for all purposes.

### BACKGROUND

Embodiments of the present invention relate generally to methods and apparatus for separating workpieces and, more specifically, to methods for separating workpieces by propagating a crack through a previously-formed full body crack.

Lasers have been used for cleaving brittle materials such as glass sheets. For example, a first laser beam heats up the glass along a desired line of separation and a coolant nozzle follows behind to cool the surface of glass. Surface tension within the sheet builds up upon cooling, resulting in the formation of an initiation crack (i.e., a “blind crack”) having a depth that is about 10 to 20% of the thickness of the sheet. After creating the initiation crack, a second laser beam is scanned along the line of separation to drive the initiation crack through the thickness of the sheet, thereby generating a “full body crack”.

It is often desirable to cleave sheets of glass along two orthogonal directions (i.e., in one or more “cross cut” operations) to form many smaller pieces of glass. In one traditional cross cut operation, a blind crack is first formed within the workpiece to extend along a first desired line of separation. Next, a full body crack is formed within the workpiece to extend along a second desired line of separation, orthogonal to the first desired line of separation. The workpiece is then separated into two unit pieces along the full body crack such that each unit piece has the aforementioned blind crack formed therein. Lastly, the blind crack in each unit piece is propagated to divide the unit pieces further into sub-unit pieces. The blind crack can be propagated using a laser or by applying a mechanical force to the unit pieces. While this method is effective in separating a workpiece into multiple pieces, it requires numerous steps that can be time consuming, thus reducing throughput.

### BRIEF DESCRIPTION OF THE DRAWINGS

FIG. 1 schematically illustrates a perspective view of an exemplary workpiece that may be separated according to embodiments of the present invention.

FIG. 2 schematically illustrates one embodiment of an apparatus for separating the workpiece shown in FIG. 1.

FIG. 3 schematically illustrates a perspective view of one embodiment of a cleavage surface formed in a workpiece.

FIG. 4 schematically illustrates a perspective view of one embodiment of another cleavage surface intersecting the cleavage surface shown in FIG. 3.

FIG. 5 schematically illustrates a perspective view of one embodiment of sub-unit pieces separated from the workpiece upon forming the cleavage surfaces shown in FIGS. 3 and 4.

FIGS. 6 to 8 schematically illustrate workpiece fixturing systems according to some embodiments.

### DETAILED DESCRIPTION OF THE ILLUSTRATED EMBODIMENTS

Embodiments of the present invention are described more fully hereinafter with reference to the accompanying drawings, in which example embodiments of the invention are shown. These embodiments may, however, be implemented in many different forms and should not be construed as limited to the embodiments set forth herein. Rather, the embodiments are provided so that this disclosure will be thorough and complete, and will fully convey the scope of the invention to those skilled in the art. In the drawings, the shapes, sizes and relative sizes of layers, regions, components, may be exaggerated for clarity. Unless otherwise specified, a range of values, when recited, includes both the upper and lower limits of the range, as well as any sub-ranges there between.

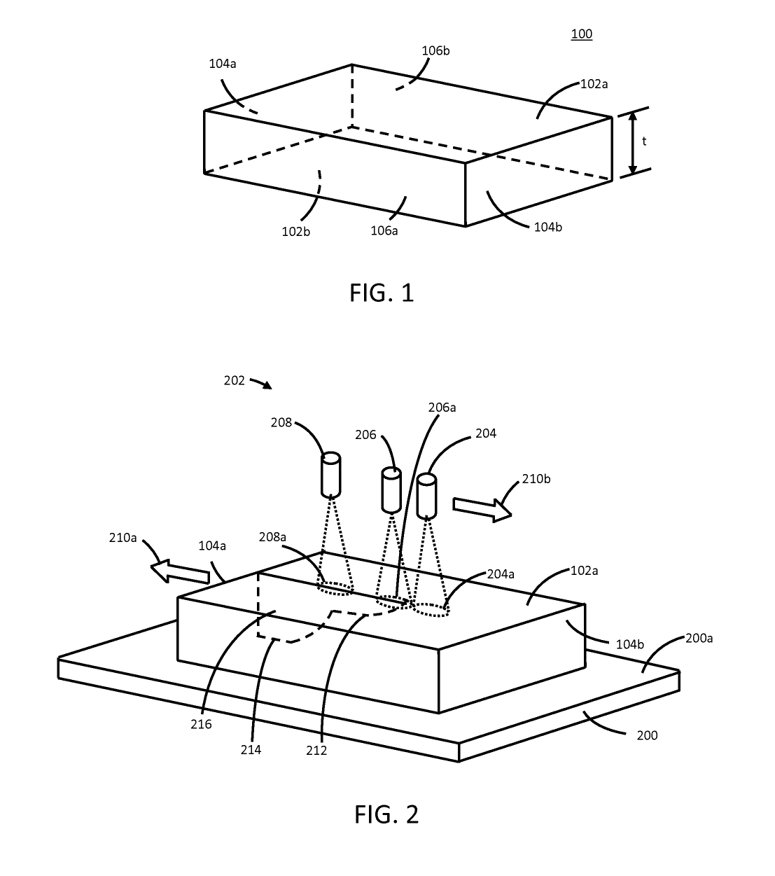

Referring to FIG. 1, a workpiece 100 includes an exterior surface having a first major surface 102a, a second major surface 102b opposite the first major surface 102a, and one or more side surfaces extending from the first major surface 102a to the second major surface 102b. As exemplarily illustrated however, the workpiece 100 includes a first pair of opposing side surfaces 104a and 104b and a second pair of opposing side surfaces 106a and 106b.

In the illustrated embodiment, the first major surface 102a and the second major surface 102b are both substantially flat are parallel to one another. Accordingly, the distance from the first major surface 102a and the second major surface 102b can define the thickness, t, of the workpiece 100. In one embodiment, the thickness of the workpiece 100 is in a range from 30 μm to 1 mm. In another embodiment, the thickness of the workpiece 100 is 700 μm or less. In yet another embodiment, the thickness of the workpiece 100 is 200 μm or less. Generally, the workpiece 100 is formed of a brittle material such as sapphire, silicon, a ceramic, a glass, a glass-ceramic, or the like or a combination thereof. In one embodiment, the workpiece 100 is provided as a sheet of unstrengthened glass. The sheet of glass can be formed of any glass composition such as soda-lime glass, borosilicate glass, aluminosilicate glass, aluminoborosilicate glass, sodium-aluminosilicate glass, calcium-aluminosilicate glass, phosphate glass, fluoride glass, chalcogenide glass, bulk metallic glass, or the like, or a combination thereof.

The workpiece 100 may be separated by workpiece separating apparatus exemplarily shown in FIG. 2. Generally, the workpiece separating apparatus may include a workpiece support 200 having a workpiece support surface 200a, and a workpiece cleaving system 202. The workpiece support may be provided as a chuck (e.g., a vacuum chuck, an electrostatic chuck, or the like or a combination thereof) configured to support the workpiece 100 on the workpiece support surface 200a. In embodiments in which the thickness of the workpiece 100 is greater than about 200 μm, the workpiece cleaving system 202 includes a first laser 204, a coolant nozzle 206 and a second laser 208. In embodiments in which the thickness of the workpiece 100 is less than or equal to about 200 μm, the coolant nozzle 206 and, optionally, the second laser 208, may be omitted from the workpiece cleaving system 202.

The apparatus may further include one or more motors, actuators, or the like, that are configured to cause relative motion between the workpiece support 200 and the workpiece cleaving system 202. For example, the workpiece support 200 may be caused to move relative to the workpiece cleaving system 202 (e.g., along the direction indicated by arrow 210a), the workpiece cleaving system 202 may be caused to move relative to the workpiece support 200 (e.g., along the direction indicated by arrow 210b), or a combination thereof. In embodiments in which the thickness of the workpiece 100 is greater than about 200 μm, relative motion between the workpiece support 200 and the workpiece cleaving system 202 can cause the workpiece 100 to be scanned relative to the workpiece cleaving system at a scan rate in a range from 200 mm/s to 300 mm/s. In embodiments in which the thickness of the workpiece 100 is less than or equal to about 200 μm, relative motion between the workpiece support 200 and the workpiece cleaving system 202 can cause the workpiece 100 to be scanned relative to the workpiece cleaving system at a scan rate in a range from 200 mm/s to 400 mm/s.

The first laser 204 is configured to direct a laser beam onto the workpiece 100. The first laser 204 may also be provided with beam shaping optics and the like so that the laser beam is directed onto the workpiece 100 to form a first beam spot 204a having any desired shape (e.g., an elliptical shape with dimensions of about 150 mm×about 10 mm). The wavelength of light within the laser beam directed by the first laser 204 may correspond to the material from which the workpiece 100 is formed. For example, in embodiments where the workpiece 100 is a sheet of glass, light within the laser beam can have at least one wavelength in a range from 9 μm to 11 μm (e.g., 10.6 μm). Configured as exemplarily described above, the first laser 204 can heat a portion of the first major surface 102a illuminated within the first beam spot 204a to generate a tensile stress within the workpiece 100. In embodiments in which the thickness of the workpiece is greater than about 200 μm, the first laser 204 can be provided as a CO₂ laser (e.g., a CW 200 W CO₂ laser or a modulated CO₂ laser with an average power of 200 W). In embodiments in which the thickness of the workpiece is less than or equal to about 200 μm, the first laser 204 can be provided as a CO₂ laser (e.g., a 150 W CO₂ laser, either CW or modulated).

The coolant nozzle 206 is configured to eject a coolant onto a cooling spot 206a onto the first major surface 102a of the workpiece 100. The coolant may, for example, include water, air, helium gas, nitrogen gas, carbon dioxide gas, or the like or a combination thereof. When the workpiece 100 is scanned relative to the workpiece cleaving system 202, the cooling spot 206a follows the first beam spot 204a and the coolant ejected by the coolant nozzle 206 rapidly cools the portion of the first major surface 102a that was previously heated upon being illuminated by first beamspot 204a. Cooling the first major surface 102a in this manner generates a compressive stress within the workpiece 100 sufficient to form a blind crack 212 within the workpiece 100. In one embodiment, the first laser 204 and the blind crack 212 extend from the first major surface 102a into the workpiece 100 to a depth in a range of about 10% to 20% of the thickness of the workpiece 100.

The second laser 208 is configured to direct a laser beam onto the workpiece 100. The second laser 208 may also be provided with beam shaping optics and the like so that the laser beam is directed onto the workpiece 100 to form a beam spot 208a having any desired shape (e.g., an elliptical shape with dimensions of about 150 mm×about 10 mm). The wavelength of light within the laser beam directed by the second laser 208 may correspond to the material from which the workpiece 100 is formed, and may be the same as or different from the wavelength of light within the laser beam directed by first laser 204. In one embodiment, the second laser 208 can be provided as a CO₂ laser (e.g., a CW 200 W CO₂ laser or a modulated CO₂ laser with an average power of 200 W). Configured as exemplarily described above, the second laser 208 can heat a portion of the first major surface 102a illuminated within the second beam spot 208a that was previously cooled by the coolant ejected from the coolant nozzle 206 to propagate the blind crack 212 through the thickness of the workpiece 100 and form a full body crack 214 extending through the thickness of the workpiece 100 (e.g., from the first major surface 102a to the second major surface 102b). The full body crack 214 breaks chemical bonds (e.g., covalent bonds, ionic bonds, or the like) between atoms or molecules within the workpiece 100 to form a pair of facing cleavage surfaces 216 that extend through the thickness of the workpiece 100 (e.g., from the first major surface 102a to the second major surface 102b). It will be appreciated that the full body crack 214 can be formed and propagated through the workpiece 100 according to any other suitable process. For example, the full body crack 214 can be formed and propagated as described in any of U.S. Pat. No. 6,489,588, issued Dec. 3, 2002, U.S. Pat. No. 7,772,522, issued Aug. 10, 2010, U.S. Pat. 7,820,941 issued Oct. 26, 2010, U.S. Patent App. Pub. No. 2010/0294748, published Nov. 25, 2010, U.S. Patent App. Pub. No. 2007/0151962, published Jul. 5, 2007, all of which are incorporated herein by reference.

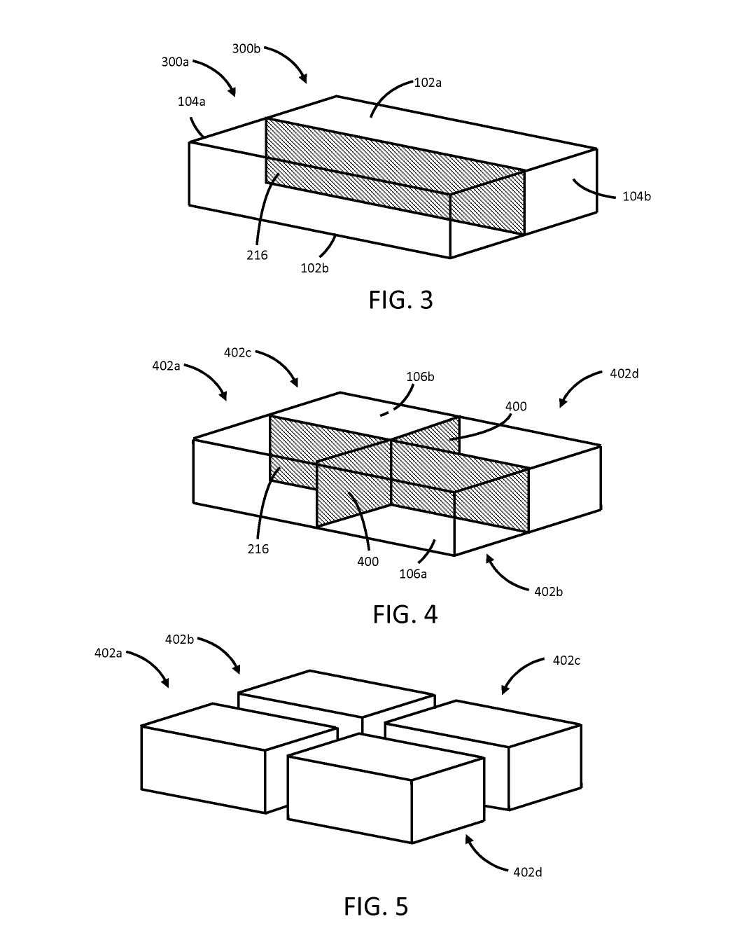

As exemplarily illustrated in FIG. 2, the full body crack 214 can be initially formed at a side surface (e.g., side surface 104a) and can then be propagated into the workpiece 100 by moving the workpiece cleaving system 202 (e.g., along the direction indicated by arrow 210b), or a combination thereof. For example, as shown in FIG. 3, the full body crack 214 can be propagated into the workpiece 100 along a desired path of separation (e.g., a along straight path as illustrated, or along a curved path, or a combination thereof) to another side surface (e.g., side surface 104b). Upon propagating the full body crack 214 from side surface 104a to side surface 104b, the facing cleavage surfaces 216 are also formed to extend from side surface 104a to side surface 104b. While FIG. 3 illustrates the facing cleavage surfaces 216 as extending from side surface 104a to side surface 104b, it will be appreciated that the facing cleavage surfaces 216 can terminate within the body of the workpiece 100 or can terminate at any other side surface of the workpiece 100.

Because the aforementioned chemical bonds between atoms or molecules on either side of the facing cleavage surfaces 216 are broken the workpiece can, in one embodiment, be subsequently separated at the facing cleavage surfaces 216 into a first unit piece 300a and a second unit piece 300b abutting the first unit piece 300a. However the inventors have discovered, quite unexpectedly, that a crack can be propagated across the facing cleavage surfaces 216 if the relative positions of the first unit piece 300a and second unit piece 300b remain substantially unchanged after the facing cleavage surfaces 216 has been formed and propagated through the workpiece 100. While not wishing to be bound by any particular theory, it is believed that atoms or molecules disposed at one side of the facing cleavage surfaces 216 (e.g., within the first unit piece 300a) still remain attracted to atoms or molecules disposed at the other side of the facing cleavage surfaces 216 (e.g., within the second unit piece 300b) due to van der Waals forces across the facing cleavage surfaces 216. While the van der Waals interactions are relatively weak compared to covalent and ionic bonds, it is believed that the van der Waals interactions are sufficiently strong to allow the a crack to propagate through one portion of the workpiece 100, across the facing cleavage surfaces 216, and into another portion of the workpiece 100. The attractive interaction due to van der Waals force is inversely proportional to the sixth power of the distance of separation (measured in meters). Thus changing the initial spatial relationship between the first unit piece 300a and the second unit piece 300b, even by a millimeter, can destroy the van der Waals interactions across much of a newly formed facing cleavage surfaces 216.

In view of the above, and with reference to FIG. 4, the above described cleavage process (also referred to herein as the “first cleavage process”) of forming the facing cleavage surfaces 216 (also referred to herein as the “first cleavage surface”) can be repeated to form a second pair of facing cleavage surfaces 400 (also referred to herein as a “second cleavage surface”), when the spatial relationship between the first unit piece 300a and the second unit piece 300b is at least substantially maintained after the first cleavage process. That is, a crack (e.g., a blind crack, a full body crack, or a combination thereof) can be propagated from the first unit piece 300a, across the first facing cleavage surfaces 216, and into the second unit piece 300b. In the illustrated embodiment, the second facing cleavage surfaces 400 is illustrated as extending through the thickness of the workpiece 100 (e.g., from the first major surface 102a to the second major surface 102b), and extending completely between side surface 106a and side surface 106b. As with the first facing cleavage surfaces 216, the second facing cleavage surfaces 400 breaks the aforementioned chemical bonds between atoms or molecules within the first unit piece 300a, enabling the first unit piece 300a to be subsequently separated at the second facing cleavage surfaces 400 into a first sub-unit piece 402a and a second sub-unit piece 402b, as shown in FIG. 5. Likewise, the second facing cleavage surfaces 400 breaks the aforementioned chemical bonds between atoms or molecules within the second unit piece 300b, enabling the second unit piece 300b to be subsequently separated at the second facing cleavage surfaces 400 into a third sub-unit piece 402c and a fourth sub-unit piece 402d, as shown in FIG. 5.

While FIG. 4 illustrates the second facing cleavage surfaces 400 as extending from side surface 106a to side surface 106b. It will be appreciated that the second facing cleavage surfaces 400 can terminate within the body of the second unit piece 300b or can terminate at any other side surface of the second unit piece 300b or the first unit piece 300a (e.g., depending on the configuration of the first facing cleavage surfaces 216). In addition, while FIG. 4 illustrates the first facing cleavage surfaces 216 as extending along a first direction and the second facing cleavage surfaces 400 as extending along a second direction perpendicular to the first direction, it will be appreciated that the first and second directions can be oriented relative to each other at any angle other than 90°. To permit propagation of the second facing cleavage surfaces 400 along the second direction, the workpiece support 200 may be rotated (e.g., 90°) relative to the workpiece cleaving system 202, the workpiece cleaving system 202 may be rotated (e.g., 90°) relative to the workpiece support 200, the workpiece 100 may be rotated relative to the workpiece support surface 200a, or the like or a combination thereof.

Further, while FIGS. 2 to 4 illustrate the formation of the first facing cleavage surfaces 216 and the second facing cleavage surfaces 400 as involving two distinct steps, it will be appreciated that the workpiece 100 can be separated at least once by propagating the first facing cleavage surfaces 216 back across itself. Also, while FIG. 4 illustrates a process in which a full body crack is propagated across the first facing cleavage surfaces 216, it will be appreciated that a blind crack of any depth may also be propagated across the first facing cleavage surfaces 216. It will further be appreciated that additional cracks or cleavage surfaces can be propagated across any portion of the first facing cleavage surfaces 216 or the second facing cleavage surfaces 400 into one or more or all of the sub-unit pieces 402a, 402b, 402c, or 402d by repeating the workpiece separation processes described above.

The spatial relationship between the unit pieces (or sub-unit pieces, etc.) may be at least substantially maintained in any suitable manner. Accordingly, the workpiece separating apparatus may optionally include a workpiece fixturing system configured to at least substantially maintain the spatial relationship between the unit pieces (or sub-unit pieces, etc.) on the workpiece support surface 200a during the workpiece separation process. It will be appreciated, however, that the workpiece fixturing system is optional, and does not need to be used if the unit pieces (or sub-unit pieces, etc.) on the workpiece support surface 200a will not substantially move during the workpiece separation process. Nevertheless, it will be appreciated that the workpiece fixturing system may include one or more mechanisms suitable for restraining undesirable movement of any unit pieces (or sub-unit pieces, etc.) formed during the workpiece separation process. For example, the workpiece fixturing system may include a clamp or the like configured to exert a force on the workpiece 100 to against the workpiece support surface 200a.

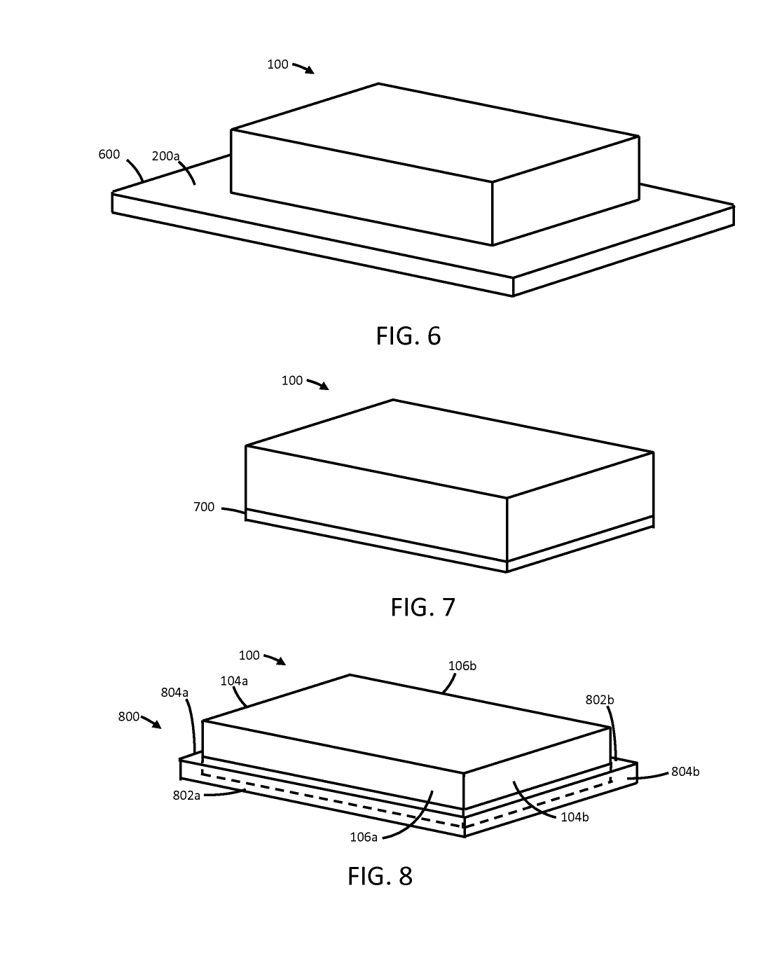

In one embodiment, and with reference to FIG. 6, the workpiece fixturing system may include the aforementioned workpiece support 200 provided, for example, as a chuck 600 (e.g., a vacuum chuck, an electrostatic chuck, or the like or a combination thereof) configured to bias the workpiece (or unit pieces, sub-unit pieces, etc.) against the support surface 200a.

In another embodiment, and with reference to FIG. 7, the workpiece fixturing system may include an adhesive 700 configured to be applied to the second major surface 102b of the workpiece 100 (or to a corresponding surface of any unit pieces, sub-unit pieces, etc., separated from the workpiece 100). The adhesive 700 may be provided as glue, one or more strips of tape, or the like or a combination thereof.

In another embodiment, and with reference to FIG. 8, the workpiece fixturing system may include a brace system 800 configured to constrain movement of the workpiece 800 relative to the workpiece support surface 200a shown in FIG. 2. Thus the brace system 800 may be disposed on the workpiece support surface 200a with the workpiece 100. In the illustrated embodiment, the brace system 800 includes a first pair of opposing brace members 802a and 802b and a second pair of opposing brace members 804a and 804b. The brace system 800 is not necessarily configured to exert a force against the workpiece 100. Rather, the workpiece is simply configured to at least substantially maintain the spatial relationship between unit pieces (or sub-unit pieces, etc.) that are formed upon forming one or more of the cleavage surfaces as exemplarily described above.

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. In view of the foregoing, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A method, comprising:
providing a workpiece;
cleaving the workpiece to form a first unit piece and a second unit piece having a spatial relationship with the first unit piece in which the second unit piece abuts the first unit piece; and
without substantially altering the spatial relationship after cleaving the workpiece:
forming a first crack within the first unit piece; and
propagating the first crack from the first unit piece into the second unit piece.

2. The method of claim 1, wherein the workpiece has a thickness of less than 1 mm.

3. The method of claim 2, wherein the workpiece has a thickness of less than or equal to 200 μm.

4. The method of claim 1, wherein cleaving the workpiece comprises irradiating the workpiece with a laser beam.

5. The method of claim 1, wherein cleaving the workpiece comprises propagating a second crack through the workpiece.

6. The method of claim 5, wherein the propagating the second crack comprises propagating the second crack through a thickness of the workpiece.

7. The method of claims 5, wherein
propagating the first crack from the first unit piece into the second unit piece comprises propagating the first crack in a first direction, and
wherein the propagating the second crack through the workpiece comprises propagating the second crack in a second direction at least substantially perpendicular to the first direction.

8. The method of claim 1, wherein forming the first crack comprises irradiating the first unit piece with a laser beam.

9. The method of claims 1, wherein propagating the first crack comprises irradiating the second unit piece with a laser beam.

10. The method of claims 1, further comprising cleaving the first unit piece into a first sub-unit piece and a second sub-unit piece.

11. The method of claim 10, wherein cleaving the first unit piece comprises irradiating the first unit piece with a laser beam.

12. The method of claims 10, wherein cleaving the first unit piece comprises propagating the first crack through a thickness of the first unit piece.

13. The method of claims 1, further comprising cleaving the second unit piece into a third sub-unit piece and a fourth sub-unit piece.

14. The method of claim 13, wherein cleaving the second unit piece comprises irradiating the second unit piece with a laser beam.

15. The method of claims 13, wherein cleaving the second unit piece comprises propagating the first crack through a thickness of the second unit piece.

16. A method, comprising:
providing a workpiece formed of a material;
forming facing cleavage surfaces within the material, the cleavage surfaces extending between a first portion and a second of the workpiece and extending through a thickness of the workpiece; and
while substantially maintaining the spatial relationship:
forming a crack within a first portion of the material adjacent to a first of the cleavage surfaces; and
propagating the crack through the cleavage surface from the first region into a second portion of the material adjacent to a second of the cleavage surfaces opposite the first cleavage surface.

17. The method of claim 16, wherein the material includes at least one selected from the group consisting of a glass and ceramic.

18. The method of claims 16, wherein the cleavage surface divides the workpiece into a first unit piece and a second unit piece.

19. A method, comprising:
providing a workpiece;
performing a first cleaving process by cleaving the workpiece to form a first unit piece and a second unit piece having a spatial relationship with the first unit piece in which the first unit piece abuts the second unit piece;
performing a second cleaving process by cleaving at least one of the first unit piece and the second unit piece to form to a plurality of sub-unit pieces; and
at least substantially maintaining the spatial relationship after the first cleaving process and during the second cleaving process.

20. An article of manufacture formed according to a method as claimed in any of claims 1.

21. An apparatus, comprising:
a workpiece support surface configured to support a workpiece;
a workpiece cleaving system configured to cleave a workpiece supported by the workpiece support system into a first unit piece and a second unit piece having a spatial relationship with the first unit piece in which the first unit piece abuts the second unit piece; and
a workpiece fixturing system configured to at least substantially maintain the spatial relationship between the first and second unit pieces on the workpiece support surface.

22. The apparatus of claim 21, wherein the workpiece cleaving system is configured to perform a process as claimed in any of claims 1.

23. The apparatus of claim 22, wherein the workpiece cleaving system comprises a laser.

24. The apparatus of claims 21, wherein the workpiece fixturing system comprises a chuck defining the workpiece support surface and configured to bias the workpiece against the workpiece support surface.

25. The apparatus of claim 24, wherein the chuck is at least one selected from the group consisting of an electrostatic chuck and a vacuum chuck.

26. The apparatus of claims 21, wherein the workpiece fixturing system comprises an adhesive configured to be adhered to the workpiece.

27. The apparatus of claims 21, wherein the workpiece fixturing system comprises a brace system configured to constrain movement of the workpiece relative to the workpiece support surface.
